(19) United States
(12) Patent Application Publication
(10) Pub. No.: US 2002/0179242 A1
(43) Pub. Date: Dec. 5, 2002

(54) Methods and apparatus for dispensing labels and label strips for use in the same

(76) Inventor: Thomas M. Wien, Newport Beach, CA (US)

Correspondence Address: Eric K. Satermo, P.O. Box 19099, Irvine, CA, 92623-9099, US

(21) Appl. No.: 10/134,044

(22) Filed: Apr. 27, 2002

Related U.S. Application Data
(60) Provisional application No. 60/288,406, filed on May 3, 2001.

(51) Int. Cl. B32B 35/00; B32B 31/00

(52) U.S. Cl. 156/344; 156/577

(57) ABSTRACT

Apparatus for dispensing and applying labels includes a label assembly and a handheld dispenser. The label assembly may include a spool and a label strip. The label strip has a base layer, an adhesive layer, and a plurality of label elements, such as graphics or alphanumeric text. The adhesive layer is coated onto the base layer with the label elements discretely coated onto the adhesive layer in a single-file manner such that a blank space is defined between adjacent label elements. The dispenser includes a spindle for receiving the spool and an applicator configured to enable one of the label elements in combination with a section of the adhesive layer to be applied to a surface. The section of adhesive layer that is applied may be defined as extending from the blank space on one side of the label element to the blank space on the other side of the label element. The combination of label element and the section of the adhesive layer applied to a surface defines a label in accordance with the invention.

### CROSS REFERENCE TO RELATED APPLICATIONS

The present application claims priority on U.S. Provisional Application for Patent Serial No. 60/288,406 filed May 3, 2001.

### BACKGROUND OF THE INVENTION

1. Field of the Invention

The present invention relates to film dispensers and, more particularly, to manually operated film dispensers that are configured to apply material to a surface. The film dispensers of the present invention are configured to enable a user to dispense and apply a label to a surface by utilizing only one hand.

2. Description of the Related Art

The art of film dispensers has evolved through a number of platforms defined by the type of film that is being applied to a surface. Each type of dispenser is designed so that a user can apply some type of material—such as correction tape or highlighting tape—to a surface with only one hand operating the dispenser.

Most of the earliest types of film dispensers were designed to apply correction tape to a surface, an example of which is disclosed in U.S. Pat. No. 5,759,270, issued Jun. 2, 1998, to Lee. Correction tape dispensers provided an alternative to conventional correction fluid. Another platform of conventional film dispenser is directed to highlighting tape, an example of which is disclosed in U.S. Pat. No. 5,707,482, issued Jan. 13, 1998, to Fusselman. Multipurpose dispensers for correction tape, reinforcement tape, and the like are disclosed in U.S. Pat. Nos. 4,772,355 and 4,824,517, issued respectively Sep. 20, 1988, and Apr. 25, 1989, to Leahy, wherein tape or tabs are dispensed by pulling on the free end of the tape. Highlighting tape dispensers preferably provided pressure-sensitive tape so that text can be highlighted with the tape and then removed if desired. Such an arrangement provided an alternative to permanent highlighting ink. Other platforms of film dispensers are designed to apply glue and adhesive tape to a surface.

One platform of film dispenser that has not yet been perfected and, therefore, commercialized relates to labels. Conventional sheets or strips of labels typically include a backing sheet with a release coating on which one or more labels with adhesive are applied. The adhesive may be pressure sensitive adhesive, either of the permanent or removable type. It is known in the prior art to dispense labels one at a time from carrier strips, for example, as in the case of a coil of labels manually dispensed from a box wherein individual labels are peeled off the carrier strip as the strip is pulled out of the box past a peel edge. The difficulty lies in the dispensing of the labels in a manner that enables single-hand application. Although labels may be dispensed from a specialized dispenser, they cannot be applied directly from the dispenser to a surface: a user needs to remove the label from the backing strip with one hand to apply the label to the surface. In addition, because of the adhesive, pressure needs to be applied by hand to the label to ensure that the label is adhered securely to the surface.

In view of the foregoing, there remains a need in the art for a label assembly and a complementary dispenser that enables labels to be dispensed and applied to a surface with the user employing only one hand.

### BRIEF SUMMARY OF THE INVENTION

According to a preferred embodiment of the present invention, apparatus for dispensing labels includes a label assembly and a dispenser. The label assembly may include a spool and a label strip. The label strip has a base layer, an adhesive layer, and a plurality of label elements, such as graphics or alphanumeric text. The adhesive layer is coated onto the base layer with the label elements discretely coated onto the adhesive layer in a single-file manner such that a blank space is defined between adjacent label elements.

The dispenser includes a spindle for receiving the spool and an applicator configured to enable one of the label elements in combination with a section of the adhesive layer to be applied to a surface. The section of adhesive layer that is applied may be defined as extending from the blank space on one side of the label element to the blank space on the other side of the label element. The combination of label element and the section of the adhesive layer applied to a surface defines a label in accordance with the invention.

To dispense and apply a label to a surface, the applicator of the dispenser is positioned and pressed to a surface. The dispenser is then moved laterally until the end of the applicator is positioned at one of the blank spaces. The adhesive layer within the blank space in which the end of the applicator is positioned may then be severed, for example, by applying pressure and moving laterally simultaneously. Accordingly, a section of the adhesive layer and at least one of the label elements adhered to the surface, thereby defining a label.

One of the advantages of the invention is that a label can be dispensed and applied with a single hand. In contrast to conventional labeling techniques in which two hands are required to remove a label from a backing strip and then to apply the removed label to a surface, the label dispensing apparatus of the present invention enables single-hand application of labels.

One of the features of the invention lies in a preferred embodiment in which the label elements include erasable ink. Accordingly, a user may erase the label element after the label has been applied to a surface. Alternatively, the adhesive layer may comprise removable-type pressure-sensitive adhesive to enhance removal of an applied label.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a schematic view of a label dispenser configured in accordance with an exemplary embodiment of the invention in which a label can be dispensed and applied to a surface;

FIG. 2 is a perspective view of a label assembly of the invention, particularly illustrating a plurality of label elements of a label strip disposed in a substantially single-file manner, thereby defining blank spaces between adjacent label elements;

FIG. 3 is an enlarged plan view of a label strip according to an exemplary embodiment of the invention in which a plurality of label elements are discretely disposed in a single-file manner to defining blank spaces between adjacent label elements;

FIG. 4A is a cross-sectional view taken along line 4-4 of FIG. 3, particularly illustrating a preferred embodiment of the label strip in which label elements are coated on a base layer and covered with an adhesive layer;

FIG. 4B is a cross-sectional view taken along line 4-4 of FIG. 3, particularly illustrating an alternative embodiment of the label strip in which an adhesive layer is coated on a base layer and an label elements are disposed on the adhesive layer;

FIG. 4C is a cross-sectional view taken along line 4-4 of FIG. 3, particularly illustrating another alternative embodiment of the label strip in which a release layer is coated on a base layer;

FIG. 5 is a fragmentary perspective view of an exemplary applicator of a dispenser of the invention;

FIGS. 6A-6D are plan views respectively illustrating successive steps of methodology for dispensing and applying labels to a surface in accordance with the present invention;

FIGS. 7A-7D are sectional elevation views respectively corresponding to FIGS. 6A-6D;

FIG. 8 is a flow chart illustrating exemplary methodology for dispensing and applying labels to a surface in accordance with the present invention;

FIG. 9 is a plan view of a label strip according to another exemplary embodiment of the invention in which label elements are made up of a plurality of sub-elements;

FIG. 10 is a fragmentary plan view of a master sheet of label strips configured in accordance with an exemplary embodiment of the invention; and

FIG. 11 is a cross-sectional view taken along line 11-11 of FIG. 10, illustrating the master sheet in more detail.

### DETAILED DESCRIPTION OF THE INVENTION

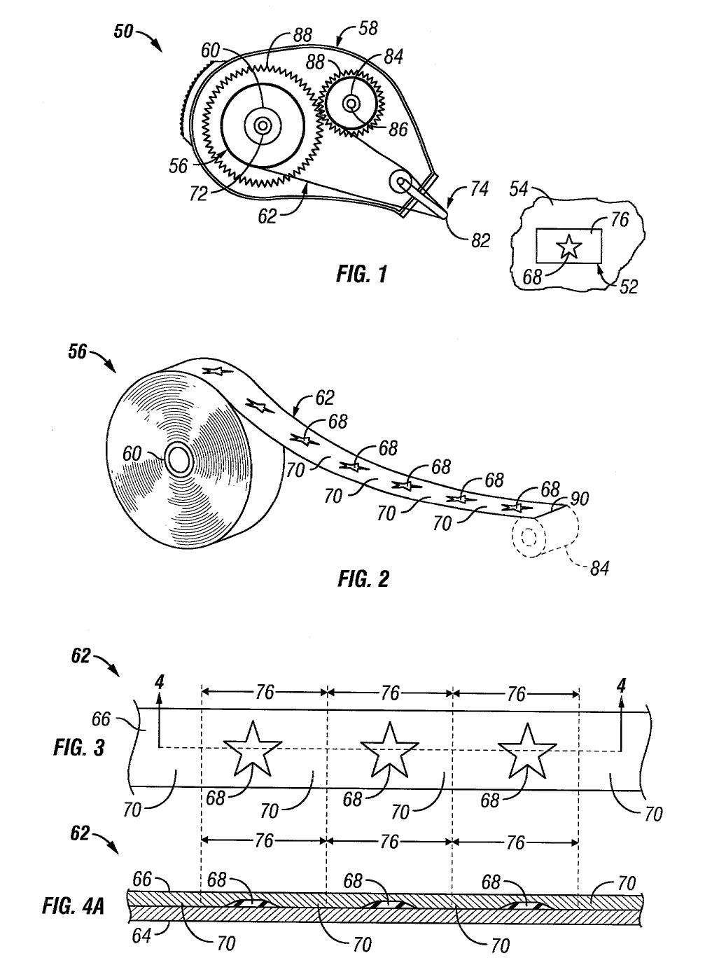

Referring more particularly to the drawings, a label dispenser 50 in accordance with an exemplary embodiment of the present invention is shown in FIG. 1. Exemplary label dispenser 50 is configured to enable a user to dispense and to apply a label 52 to a surface 54 with a single hand.

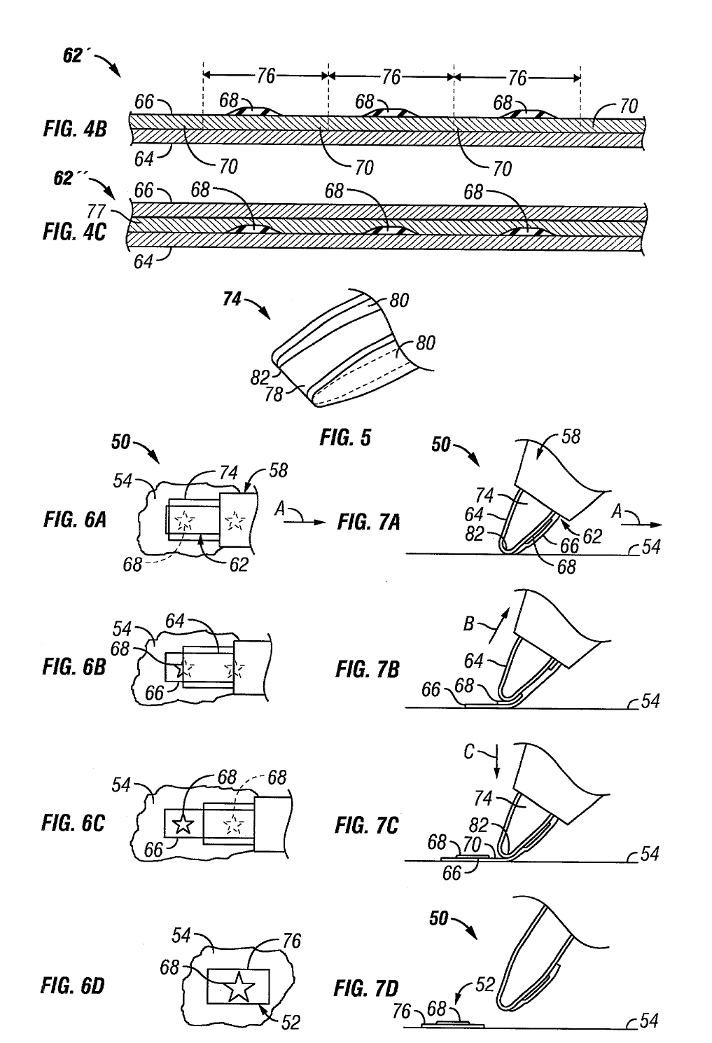

Exemplary label dispenser 50 generally includes a label assembly 56 and a dispenser 58. With additional reference to FIG. 2, exemplary label assembly 56 may include a spool 60 and a label strip 62 wound about the spool 60. As shown in FIGS. 3 and 4A, the label strip 62 may include a base layer 64, an adhesive layer 66 coated onto the base layer 64, and a plurality of label elements 68 discretely coated onto the adhesive layer 66. According to a preferred embodiment, the label elements 68 are coated onto the adhesive layer 66 in a single-file manner such that a blank space 70 is defined between adjacent label elements 68.

Referencing FIG. 1, exemplary dispenser 58 may include a spindle 72 for receiving the spool 60 of the label assembly 56 and an applicator 74. According to a preferred embodiment, the applicator 74 is configured to enable one of the label elements 68 in combination with a section 76 of the adhesive layer 66 to be applied to a surface 54. More specifically, referencing FIGS. 3 and 4A, the section 76 of the adhesive layer 66 that is applied to a surface 54 with the label element 68 may be defined as the portion of adhesive layer extending from the blank space 70 on one side of the label element 68 to the blank space 70 on the other side of the label element 68. Accordingly, the label 52 that is applied to the surface 54 includes at least one of the label elements 68 and a section 76 of the adhesive layer 66.

An alternative embodiment of the label strip of the invention is shown in FIG. 4B and indicated with reference numeral 62′. According to this embodiment, the adhesive layer 66 is coated onto the base layer 64, with the label elements 68 coated on the adhesive layer 68. Applicable sections 76 are defined between successive blank spaces 70 as described above. Comparisons between the two embodiments of the label strip 62 and 62′ shown in FIGS. 4A and 4B will be made below.

Another alternative embodiment of the label strip of the invention is shown in FIG. 4C and indicated with reference numeral 62″. Exemplary label strip 62″ includes a release coating or layer 77 applied to the base layer 64. The release layer 77 is configured to facilitate the release of the sections 76 of the adhesive layer and the label elements 68 from the base layer 64. The release layer 77 may include silicone or other like material. In addition, the release layer 77 may be configured to be receptive to ink, such as those coatings disclosed in U.S. Pat. Nos. 6,074,747 and 6,153,288 assigned to Avery Dennison Corporation, the entire disclosure of each of which is incorporated herein by reference. Ink-receptive coatings may be useful in certain preferred embodiments of the invention.

According to an exemplary embodiment, the base layer 64 of the label strips 62, 62′, 62″ may be made from any suitable flexible film material such as polyester or polypropylene. Alternatively, the base layer 64 may be a paper-based material such as a kraft liner. According to a preferred embodiment, the base layer 64 may be relatively inelastic and tear resistant when compared to the adhesive layer 66 so that under pressure, the adhesive layer 66 may be severed at a preferred location (e.g., within a blank space 70) while the base layer 64 remains intact, which is discussed in more detail below. The adhesive layer 66 may comprise an adhesive that is not permanently adherent to the base layer 64 and that is transferable from the base layer and adherent to a surface.

A number of patents assigned to Avery Dennison Corporation disclose material suitable for the base layer 64 and adhesive suitable for the adhesive layer 66, such as U.S. Pat. Nos. 6,150,035; 6,187,432; and 6,107,382, the entire disclosure of each of which is incorporated herein by reference.

The label elements 68 may be ink that is printed on the base layer 64 as shown in FIG. 4B. According to one of the preferred embodiments of the invention, the ink of the label elements 68 may be an erasable ink, which is also discussed in more detail below. According to the embodiments utilizing ink, the label 52 adhered to the surface 54 provides a “stamping” effect similar to a rubber ink stamp, as opposed to a conventional “labeling” effect, which may be preferred in many applications.

Referencing FIG. 1, as mentioned above, the dispenser 58 is configured such that a user is enabled to apply a label 52 to a surface 54. Accordingly, the dispenser 58 is preferably configured to be hand held. As shown in FIG. 5, the applicator 74 may include a surface 78 over which a label strip 62 is slidable. A pair of sidewalls 80 may be provided to guide a label strip 62 on the surface 78. The applicator 74 may also include an end 82 over which the label strip 62 is directed at an acute angle, as shown in FIG. 1.

Exemplary dispenser 58 may also include a take-up spool 84 disposed on a spindle 86. The take-up spindle 86 may be rotatably meshed by gears 88 with spindle 72 that receives the label assembly 56. The take-up spool 84 is configured to receive or attach to an end 90 of the label strip 62 (see FIG. 2). Accordingly, as shown in FIG. 1, the label strip 62 extends between the spools 60 and 84 via the applicator 74, with label assembly spool 60 unwinding while the take-up spool 84 winds. Intuitively, the label assembly 56 is mounted within the dispenser 58 so that the base layer 64, not the adhesive layer 66, is positioned against the surface 78 and the end 82 of the applicator 74.

The dispenser 58 may be configured in alternative embodiments that are in accordance with any number of conventional dispensers known in the art, examples of which include U.S. Pat. Nos. 5,759,270 to Lee; 5,759,341 to Kobayashi; 6,062,286 to Koyama et al.; and 6,206,072 to Orihara et al., the entire disclosure of each of which is incorporated herein by reference.

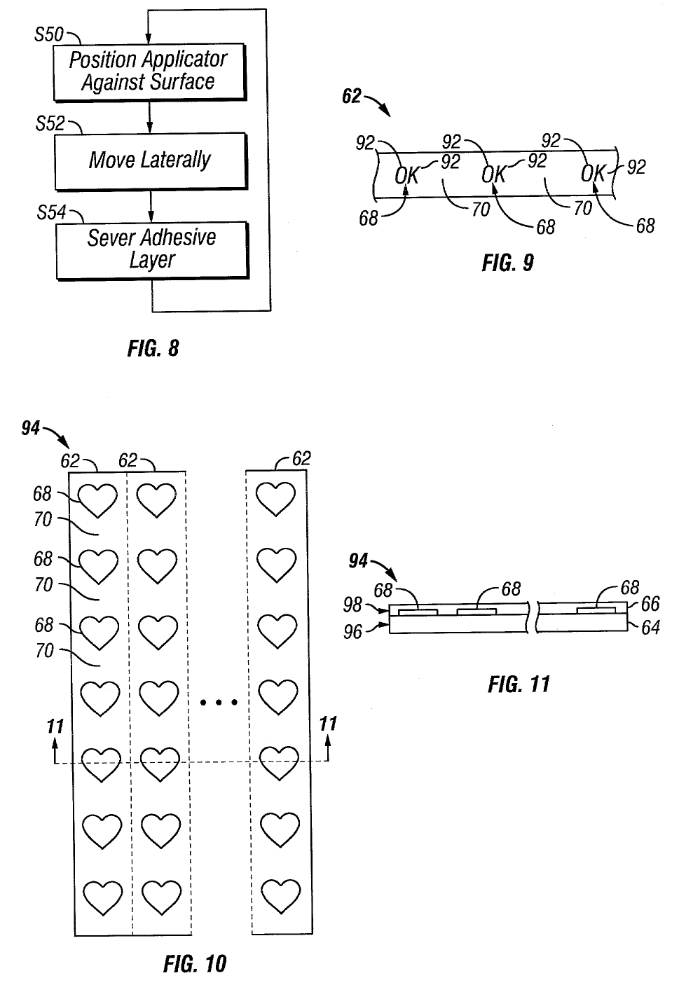

With reference to FIGS. 6A-6D, 7A-7D, and 8, according to a preferred methodology for dispensing and applying a label 52 to a surface 54, the label dispenser 50 is brought to the surface 54 with the end 82 of the applicator 74 positioned against the surface 54 (step S50 in FIG. 8). The applicator 74 may be pressed downwardly so that the adhesive layer 66 adheres to the surface 54. The dispenser 50 may then be moved laterally (step S52) as shown by arrow A while maintaining downward pressure on the applicator 74; accordingly, as shown in FIGS. 6B and 7B, a section of the adhesive layer 66 adheres to the surface 54. The base layer 66 is consequently removed of the adhesive layer 66 and the label element 68 and returns to the take-up spool 84 (see FIG. 1) as shown by arrow B in FIG. 7B.

When the dispenser 50 has been moved a lateral distance where the end 82 of the applicator 74 is positioned within the blank space 70 subsequent to the label element 68 adhered to the surface 54 as shown in FIGS. 6C and 7C, then a downward force as indicated by arrow C may be applied against the surface 54 so that the adhesive layer 66 is severed within the blank space 70 (step S54). The dispenser 58 may be moved laterally simultaneously while the downward force is applied to tear the adhesive layer 66.

As shown in FIGS. 6D and 7D, the dispenser 50 may then be removed, leaving a label 52 adhered to the surface 54. According to a preferred embodiment of the invention, the adhered label 52 that is comprised of a section 76 of the adhesive layer 68 and a label element 68 is not formed or defined until the adhesive layer 66 is severed as shown in FIG. 7C. The entire foregoing process may be carried out by a user by utilizing only a single hand to operate the dispenser 50.

When applying a label from the label strip 62 shown in FIG. 4B, the label element 68 of the label 52 is exposed as shown in FIG. 7D. In contrast, when applying a label from the label strip 62′ shown in FIG. 4B, the label element 68 is not exposed but is, rather, covered with the section 76 of the adhesive layer 66 (not shown), in which embodiment the adhesive layer 66 preferably includes substantially optically transparent adhesive. Accordingly, the label 52 from the label strip 62 of FIG. 4A with the exposed label element 68 may be configured to be erasable. More specifically, according to a preferred embodiment, the label elements 68 are made from erasable ink such that when applied as a label 52, the label element 68 may be erased, thereby leaving the section 76 of the adhesive layer 66 adhered to the surface 54.

An alternative to erasable label elements 68 is to utilize pressure-sensitive adhesive in the adhesive layer 66. Accordingly, an applied label 52 may be removed from the surface 54 by removing the section 76 of the adhesive layer 66 comprising the label 52, thereby also removing the label element.

Rather than applying a single label element 68 to the surface 54, the dispenser 50 may be moved laterally so that more than one label element 68 is applied to the surface 54 prior to severing the adhesive layer 66. In addition, as shown in FIG. 9, each of the label elements 68 may include a plurality of sub-elements 92, with the blank spaces 70 being defined between adjacent sets of sub-elements 92.

Referencing FIGS. 10 and 11, in manufacturing the label strips 62, a master sheet 94 may be formed by coating or printing the label elements 68 onto a sheet 96 of base material. An adhesive film 98 may then be coated over the label elements 68 and the sheet 96 of base material. The master sheet 94 may then be cut longitudinally between single-file columns of label elements 68 as indicated by the dashed lines in FIG. 10, thereby defining individual label strips 62. The individual label strips 62 may then be rolled about spools. Alternatively, the master sheet 94 may be rolled about a master spool (not shown) and then cut to form individual label assemblies 56 (see FIG. 2).

Those skilled in the art will understand that the preceding exemplary embodiments of the present invention provide the foundation for numerous alternatives and modifications thereto. For example, the adhesive layer 66 may include break points such as perforations within the blank spaces 70 to facilitate the severing of the adhesive layer to form the section 76 of the adhesive layer within the adhered label 52. In addition, although the label elements 68 are configured as stars (or as text shown in FIG. 8 or as hearts shown in FIG. 9) for the purposes of the foregoing description, those skilled in the art will appreciate that the label elements 68 may be configured in any type of graphic or alphanumeric text. For example, the label elements 68 may be configured as color-coding dots, arrows of any color, smiley faces, and so on, or may include text such as CONFIDENTIAL, SIGN HERE, copy, and so on. These other modifications are also within the scope of the present invention such that the present invention is not limited to that precisely as shown and described in the present invention.

What is claimed is:

1. Apparatus for dispensing labels, the apparatus comprising:
a label assembly including a spool and a label strip;
the label strip including a base layer, an adhesive layer coated onto the base layer, and a plurality of label elements discretely coated onto the adhesive layer in a single-file manner such that a blank space is defined between adjacent label elements; and
a dispenser including a spindle for receiving the spool and an applicator configured to enable one of the label elements in combination with a section of the adhesive layer extending from the blank space on one side of the label element to the blank space on the other side of the label element, to be applied to a surface.

2. Apparatus as claimed in claim 1 wherein each of the label elements includes ink.

3. Apparatus as claimed in claim 1 wherein each of the label elements includes erasable ink.

4. Apparatus as claimed in claim 1 wherein each of the label elements includes a plurality of sub-elements.

5. Apparatus as claimed in claim 1 wherein the adhesive layer includes pressure-sensitive adhesive.

6. A label assembly comprising:
a spool; and
a label strip disposed about the spool and including a base layer, an adhesive layer coated onto the base layer, and a plurality of label elements discretely coated onto the adhesive layer in a single-file manner such that a blank space is defined between adjacent label elements;
the label assembly being receivable within a dispenser such that one of label elements in combination with a section of the adhesive layer extending from the blank space on one side of the label element to the blank space on the other side of the label element, is applicable to a surface.

7. Apparatus as claimed in claim 6 wherein each of the label elements includes ink.

8. Apparatus as claimed in claim 6 wherein each of the label elements includes erasable ink.

9. Apparatus as claimed in claim 6 wherein each of the label elements includes a plurality of sub-elements.

10. Apparatus as claimed in claim 6 wherein the adhesive layer includes pressure-sensitive adhesive.

11. A method for dispensing and applying labels to a surface, the method comprising:
providing an apparatus including:
a label assembly including a spool and a label strip;
the label strip including a base layer, an adhesive layer coated onto the base layer, and a plurality of label elements discretely coated onto the adhesive layer in a single-file manner such that a blank space is defined between adjacent label elements; and
a dispenser including a spindle for receiving the spool and an applicator with an end;
pressing the applicator to a surface;
moving the dispenser laterally until the end of the applicator is positioned at one of the blank spaces;
severing the adhesive layer within the blank space in which the end of the applicator is positioned, thereby leaving a section of the adhesive layer and at least one of the label elements adhered to the surface.

12. A method as claimed in claim 11 further comprising:
repeating the pressing, moving, and severing steps.

13. A method as claimed in claim 11 wherein each of the label elements includes erasable ink, further comprising:
erasing the label element.
